(19) United States
(12) Patent Application Publication
(10) Pub. No.: US 2005/0203787 A1
(43) Pub. Date: Sep. 15, 2005

(54) Integrated account management system

(75) Inventors: Mark Stevens, Littleton, CO (US); Jeff Leisegang, Highlands Ranch, CO (US); Stan Reeves, Palmer, AK (US)

Correspondence Address: SWANSON & BRATSCHUN L.L.C., 1745 SHEA CENTER DRIVE, SUITE 330, HIGHLANDS RANCH, CO, 80129, US

(73) Assignee: Municipal Services Group, Inc., Littleton, CO (US)

(21) Appl. No.: 11/078,184

(22) Filed: Mar. 10, 2005

Related U.S. Application Data
(60) Provisional application No. 60/552,762, filed on Mar. 12, 2004.

(51) Int. Cl. G06F 17/60

(52) U.S. Cl. 705/7

(57) ABSTRACT

A fully integrated account management system is provided which permits users in multiple locations to enter and access information and manage client accounts, projects associated with accounts, and jobs associated with projects. Preferably, information is organized and stored on the basis of originating nodes or locations. Consequently, data analysis may be performed at the individual location level as well as at higher, regional and company-wide, levels.

### RELATED APPLICATION DATA

This application claims benefit of U.S. Provisional Application Ser. No. 60/552,762, filed Mar. 12, 2004, entitled INTEGRATED ACCOUNT MANAGEMENT SYSTEM, which application is incorporated herein in its entirety by reference.

### TECHNICAL FIELD

The present invention provides an integrated system and method for managing customer accounts, projects and jobs in a multi-node, computing environment.

### BACKGROUND ART

Customer relationship management (CRM) is a relatively recent term used to refer to systems and methodologies, generally computer-based, implemented by an organization to improve its relationships with customers. Prior to the advent of CRM, back-office operations, such as human resources, finance/accounting, and purchasing/vendor relations, were organized and managed substantially independently of front-office operations, such as marketing, sales and customer support. Employees were more department or product centered and employees in different departments had different views of the customers. When a CRM system is implemented, everyone in the organization ideally becomes focused on the customer and all have a unified view of the customer. The intended goal is that all of the departments will be linked around the same data, resulting in more efficient front- and back-office operations and better customer service.

Many articles have been published regarding CRM and numerous vendors market computer-based CRM applications. Consequently, a more detailed discussion of existing CRM systems will not be undertaken herein.

For a company in, for example, the engineering or construction industries, conventional CRM systems may not provide sufficient flexibility to adequately account for multiple projects being performed for a single customer (account) or for multiple jobs related to a single project. Moreover, conventional CRM systems have not enabled an organization to manage various pieces of equipment over numerous projects and jobs. Finally, conventional CRM systems have not provided integrated document management across an entire organization with numerous geographic locations.

Consequently, a need exists for a management system which can accommodate the specialized requirements of particular industries.

### SUMMARY OF THE INVENTION

The present invention provides features and functions well beyond those provided by existing CRM applications. More specifically, the present invention provides an account management system comprising a server interconnected with a network to which client devices operated by users in one or more offices of an organization are interconnected. The server comprises a memory, a storage device and a processor programmed to execute database application instructions whereby database information is accessible to the users. The database application comprises an accounts module and a document management module. The accounts module includes a general information element for providing general information pertaining to accounts of the organization, a sales call element for providing information pertaining to prospective accounts, and a project sites element for providing information pertaining to jobs associated with project sites. The document management module provides access to stored documents searchable by at least one of an associated account, associated project, associated job, an associated office and an associated category.

The database application may further include an equipment management module having an equipment inventory element, an equipment scheduling element, and an equipment maintenance scheduling element. The database application may further include an financial management module providing financial information at an account level, a project level and a job level. Still further, the database application may include a financing quote module for providing financing quotes in response to inputs specifying a project type, a project location and desired payment terms.

### BRIEF DESCRIPTION OF THE DRAWINGS

FIG. 1 illustrates a schematic overview of the account management system of the present invention;

FIG. 2 illustrates a schematic overview of an accounts module of the present invention;

FIG. 3 illustrates a schematic overview of an equipment management module of the present invention;

FIG. 4 illustrates a schematic overview of a financial management module of the present invention;

FIG. 5 illustrates a schematic overview of a document management module of the present invention;

FIG. 6 illustrates a schematic overview of a knowledge message system module of the present invention;

FIG. 7 illustrates a schematic overview of a financing quote module of the present invention;

FIG. 8 is a block diagram of the financing quoting module in a network-based environment;

FIG. 9 is a block diagram of an exemplary network-based configuration of the account management system of the present invention;

FIG. 10 is a block diagram of the primary server of FIG. 9;

FIG. 11 is a block diagram of an exemplary office of FIG. 9; and

FIG. 12 is a block diagram of the present invention in a hosted sever environment.

### DETAILED DESCRIPTION OF THE PREFERRED EMBODIMENT

The present invention provides features and functions well beyond those provided by CRM applications. In the engineering/construction management industry, a prospective client, such as a municipality, asks for bids on a project. Frequently, the project may involve more than one job or may evolve into more than one job. As used herein, an “account” refers to a client or prospective client; a “project” refers to work to be performed at a single geographic location for a client; and a “job” refers to an aspect of a project which is performed and accounted for separately from other jobs. For example, a customer may have multiple offices located in a state. If services are provided for each of the offices, the system of the present invention allows users to manage the top level account, list unique project sites within the top level account, and set-up and manage multiple jobs for the customer.

Although the present invention will be described herein in the context of the engineering/construction management industry, such description is by way of example and not limitation. The present invention is also applicable to other industries.

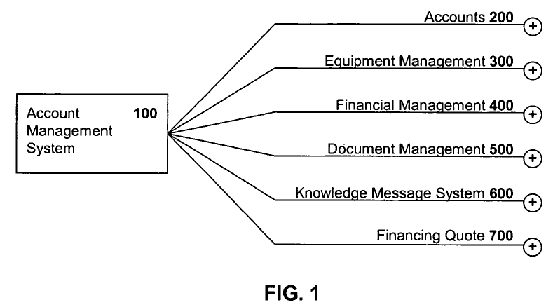

FIG. 1 illustrates a schematic overview of an account management system 100 of the present invention. Modules which may comprise the system 100 include an accounts module 200, an equipment management module 300, a financial management module 400, a document management module 500 and a knowledge message system module 600. An optional on-line financing quote module 700 may also be included in the account management system 100. If desired, access to a particular module may be limited, such as through logon passwords, to those individuals in an organization whose job responsibilities require such access. Some individuals may be granted access to more than one module or to all of the modules, depending on job functions.

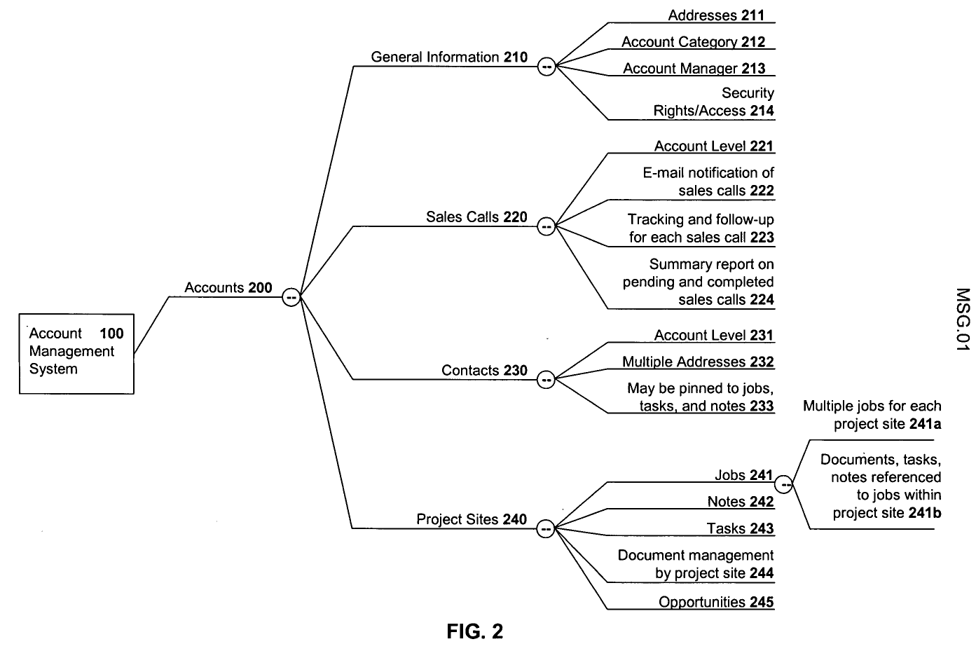

As illustrated in FIG. 2, the accounts module 200 may include general information 210 about an existing or prospective client, such as name and address 211; account category 212, such as industry type, government entity or other user defined categories; name of an account manager 213; and access information 214. A sales call element 220 may be indexed based on an associated account 221 and an individual may arrange the accounts module 200 to generate e-mail notification of sales calls 222. The sales call element 220 may also provide tracking and follow-up for each sales call with, for example, sales call scheduling 223 as well as reports on pending and completed sales calls 234.

A contacts element 230 may also be indexed based on an associated account 231 and include multiple addresses 232. Each contact entered into the system may have a job, a task and/or notes (the latter two of which will be described below) 233 “pinned” to the contact.

A project sites element 240 provides information about the jobs associated with each project 241. As described above, there may be multiple project sites associated with an account, each of which may have multiple associated jobs 241a. Information notes 242 pertaining to the project may be entered and retrieved. Similarly, tasks 243 and documents 244 pertaining to the project may be entered and retrieved. To provide even further flexibility, notes, tasks and documents may also be associated with individual jobs within a particular project 241b. Moreover, as will be described below, documents associated with a project or job are available through the document management module 500 and can thus be referred to or modified for other accounts or projects.

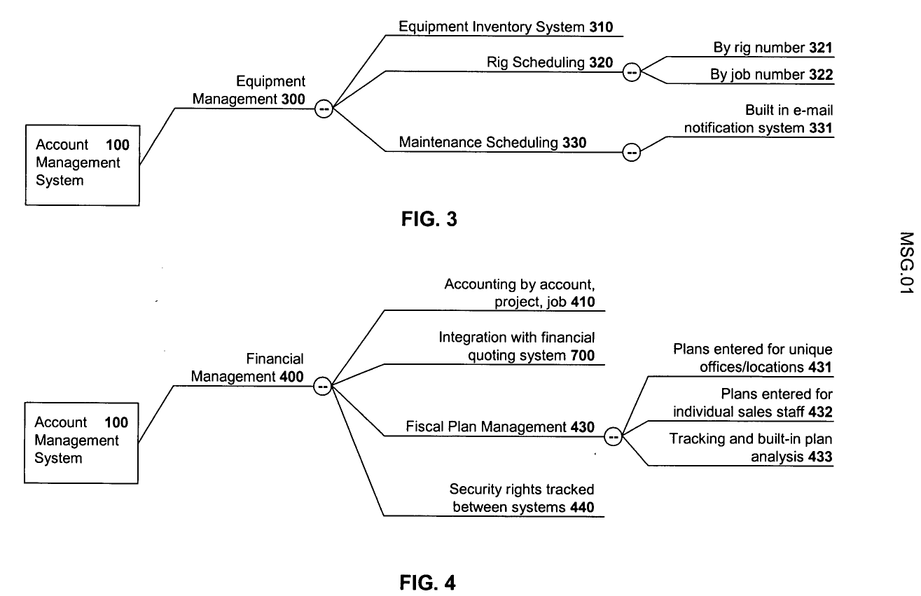

The equipment manager module 300 (FIG. 3) is also integrated into the system 100 and allows users to maintain and access an inventory of equipment 310 and schedule equipment 320 both by specific rig 321 or by the job 322. The equipment manager module 300 also provides for scheduling of maintenance 330 and may include an automatic system 331 to send e-mail notices at appropriate maintenance intervals for the various pieces of equipment. Consequently, users of the system 100 are able to determine where a particular piece of equipment is at any time, what's its maintenance state is, where it has been and where it is going. Additionally, users may also determine what equipment is currently (or scheduled for the future) on a specific job.

The financial management module 400 (FIG. 4) provides accounting features 410 enabling detailed analysis by each account, project and job. The module may also be integrated with a financing quote system 700 whereby information is integrated between the quoting system 700 and the account within the system 100.

Many organizations draft sales plans and goals. The financial management module 400 of the system 100 of the present invention includes a fiscal plan management element 430 which accommodates such planning not just for a company as a whole but also for individual offices and locations 431 as well as for individuals in each office 432. The fiscal plans may be tracked and compared with actual progress to date 433. Due to the integrated nature of the system 100, anyone in any company location may be given a pass code granting access to any of the fiscal plans and analyses. Thus, office managers are able to keep track of how well individuals in the office are doing; regional managers are able to keep track of how well individuals and offices in the region are doing; and, corporate managers are able to keep track of how well the company is doing on an individual, office and regional basis.

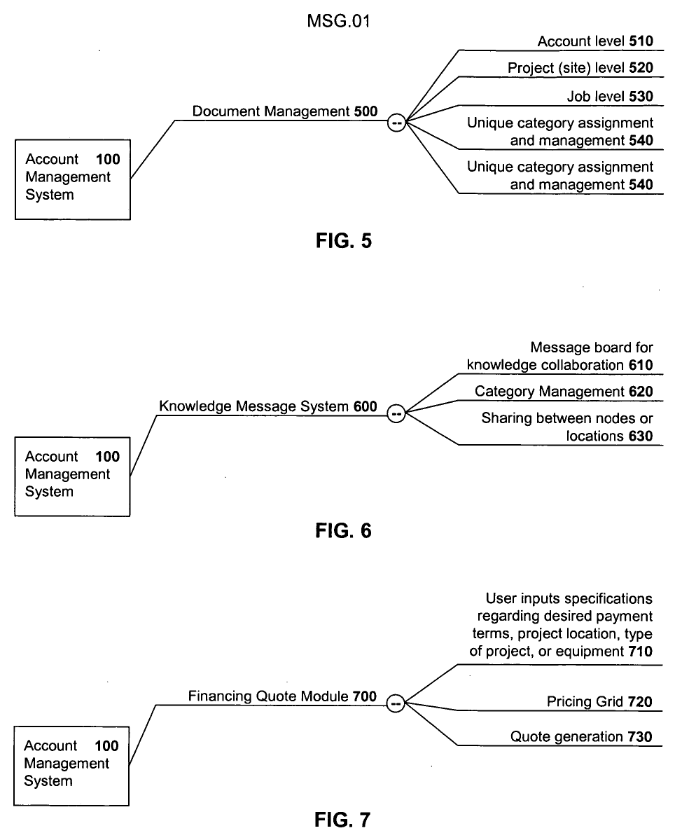

The document management module 500 (FIG. 5) permits documents of any kind to be stored, searched and retrieved. Documents may be linked not just to an account 510, but also to a project 520 or to a job 530 and may be indexed accordingly. Moreover, each document may also be assigned to a category 540. In addition to searching by account, project, job and category, searching criteria may also include the physical node or location at which a document originated 550.

The knowledge message system module 600 (FIG. 6) enables users across an organization to exchange and review messages about any business-related subject. For example, users may use the board to collaborate 610 about a prospective client. The knowledge message system module 600 also includes category management 620 which allows user-defined categories to organize on-line communications both within a node (or location) and between nodes 630, thereby providing company-wide exchange of information and ideas.

The financing quote module 700 illustrated in FIG. 7 permits a user to generate a quote with financing terms for a particular project or for equipment. The user may be someone in the office 720, such as a sales person who has been asked by a client or prospective client for a bid. Such a user may access the financing quoting module 700 through the account management system in the same way he or she accesses the other modules 200-600. Alternatively, the user may be an outside individual, such as a sales representative for an equipment manufacturer soliciting a quote for a prospective purchaser of the equipment. Such a user may access the financing quoting module 700 directly, such as through the internet, without having access to any other module 200-600. The module 700 receives inputs 710 from the user addressing such questions as desired payment terms, the location of the project being financed, the type of project and the type of equipment, if any, being financed. The module 700 then accesses a pricing grid 720, which is preferably updated regularly with current rates and other financing terms, and generates a quote 730 for the user which may form the basis for a financing proposal for the prospective purchaser.

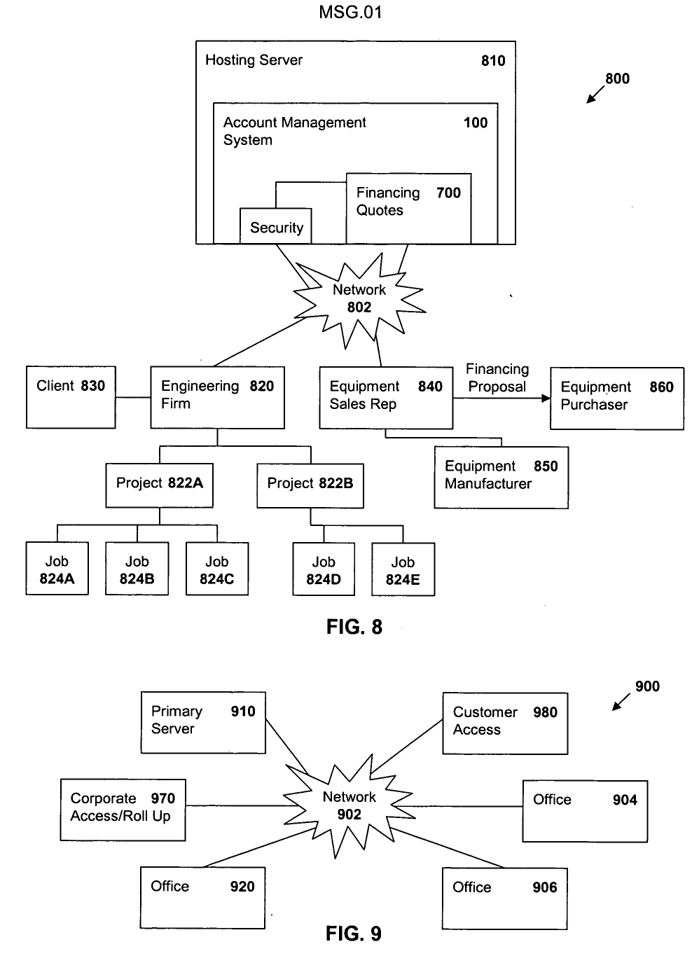

FIG. 8 illustrates a block diagram of the financing quote module 700 in a network-based environment 800. In the environment 800 illustrated, the account management system 100 is installed in a hosting server 810 and accessible to various outside parties through a network 802. For example, an engineering firm 820 may be an existing user of the system 100 and have been solicited by a client or prospective client 830, such as a municipality, to perform consulting services for several projects 822A and 822B, each of which may include several jobs 824A-E. The firm 820 may access the financing quote module 700 within the system 100. After inputting details about the project 710, the equipment desired and the payment terms desired, the financing quote module 700 accesses the internal pricing grid 720 and generates a quote 730. The engineering firm 820 receives the quote and can include it in a proposal to the prospective client 830.

In addition, a sales representative 840 for an equipment manufacturer 850 may wish to solicit business from a prospective equipment purchaser 860. The financing quote module 700 may be directly accessible to the sales representative 840 through the internet 802 without requiring access to the balance of the system 100. Thus, the sales representative 840 may obtain a financing quote and submit it to the purchaser 860 for consideration.

The account management system 100 may be installed in a networking computer environment. Individual users at the various locations or nodes are able to log in to the system 100 from any computer coupled to the network, such as through a local area network, a client-server network or internet access, even from the field if desired with wireless PDAs. Maintenance of the system 100 is the responsibility of the sponsoring company. FIG. 9 illustrates such a configuration 900 having a primary server 910. The server 910 is interconnected with a network 902 to which client devices in offices 920, 904 and 906 are also interconnected. For purposes of clarity, only three offices are illustrated in FIG. 9. It will be appreciated, however, that any number of offices may be connected to the network 902, to the limit of the network 902. The offices may be local or geographically distributed, such as in different cities, and the computer clients may be distributed throughout an individual office.

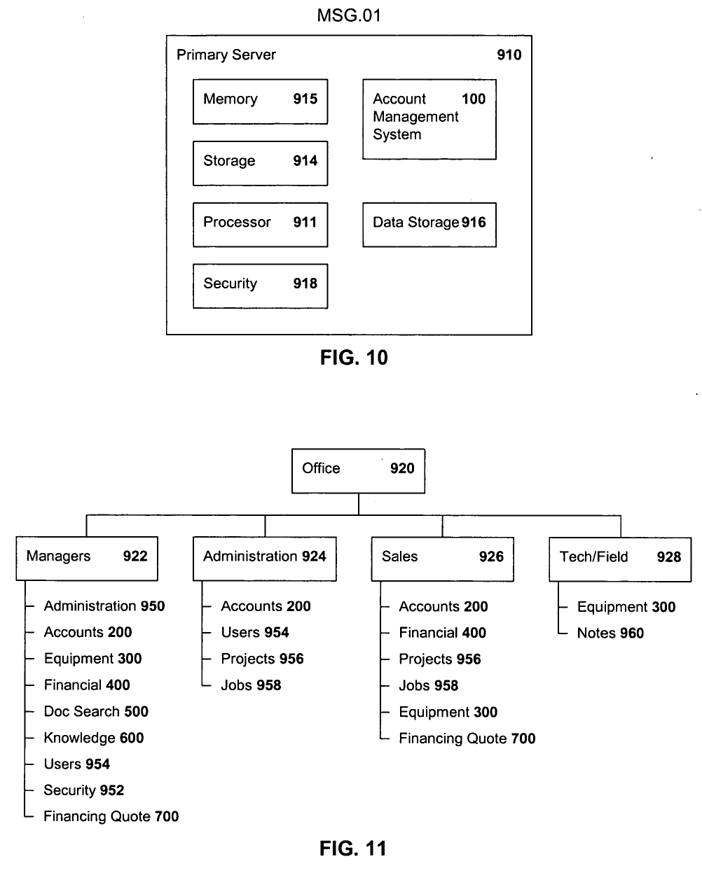

Referring to FIG. 10, the primary server 910 includes a processor 911 programmed to execute account management system application instructions 100 which may be stored in a storage device 914 and transferred into a memory 915. Database management instructions may be incorporated in the system 100 or may be a separate module external the system 100 itself. The processor operates on data written to and read from a data storage device 916, which may coincide with the storage device 914. Access security 918 is also provided to ensure that users are able to access only those modules to which they are authorized.

The office 920 is representative of the offices 904, 906 and 920 and will be described with reference to FIG. 11 in terms of the personnel which may staff it. Managers 922, having the need to access the broadest range of information in the office 920, are enabled through security pass codes to access module for the administration 950 and security 952 of the system within the office 920 as well as overseeing permissions for other users 954. A manager will also be enabled to access all of the other modules in the system 100, including the accounts module 200, the equipment module 300, the financial management module 400, the document management module 500, the knowledge message system module 600 and the financing quote module 700.

A user on the administration staff may be enabled to access the accounts module 200 as well as portions of modules related to projects 956 and jobs 958. A user on the sales force may be enabled to access the accounts 200, equipment 300, financial management 400 and the financing quote 700 modules as well as those portions of modules related to projects 956 and jobs 958. Finally, those who operate away from the office, such as technicians and field personnel 928, may be enabled to access only the equipment management module 300 and portions of modules in which relevant notes 960 are available.

It will be appreciated that additional and/or different categories of users may be granted access to the system. The above-described categories of personnel are merely exemplary and not meant to be exclusive. Similarly, users may be granted access to other and/or different modules or portions of modules than those assigned in the exemplary description above. For example, all users may utilize at least portions of the document management module 500 and the knowledge message system module 600.

Referring again to FIG. 10, those at the headquarters or corporate level 980 may have access to all of the data associated with each office 904, 906 and 920 in order to roll up data to analyze the operation of the organization as a whole as well as to analyze the operation of each local office 920, 904, 906.

The configuration 900 may also enable customer access 980 to retrieve pertinent information from portions of the modules 200-700. Preferably, such access is provided through the internet with appropriate security protections. Moreover, individual web pages may be generated for individual customers (accounts) whereby customers may view customer-related information about the account and any associated projects and jobs.

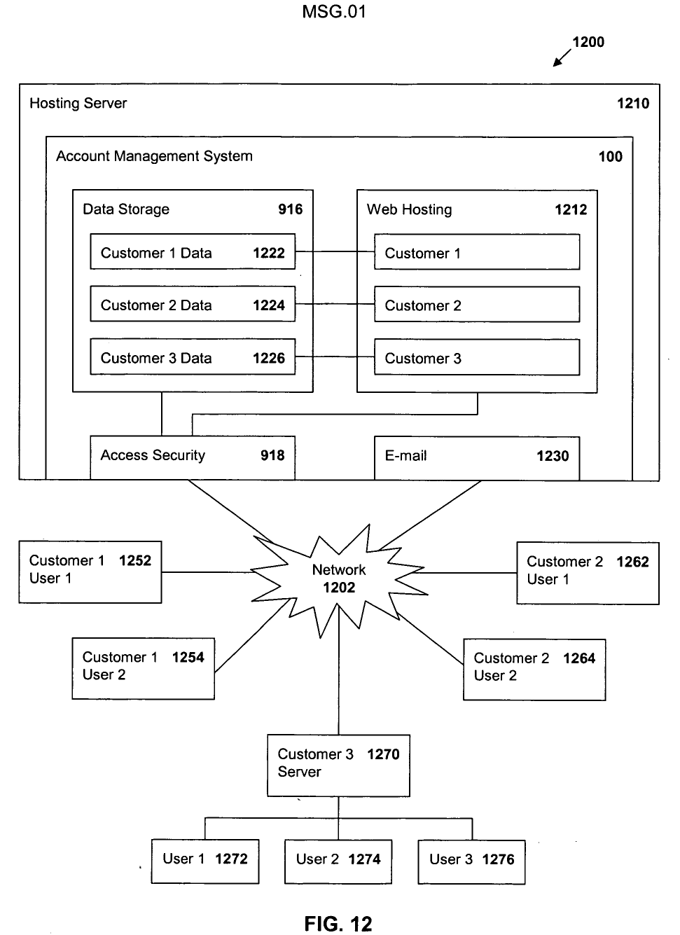

FIG. 12 is a block diagram of the present invention in a hosted sever environment 1200 in which much of the information technology infrastructure required by the organization which is to use the system 100 is eliminated. The environment 1200 includes a hosting server 1210 coupled to a network 1202, such as the internet. Also coupled to the network 1202 are customer client devices. For example, Customer 1 may include two user devices 1252 and 1254 and Customer 2 may also include two user devices 1262 and 1264, all of which access the hosting server 1210 through the network 1202. Customer 3, may include three user devices 1272, 1274 and 1276 which access the hosting server 1210 through the customer's own server 1270.

The hosting server 1210 includes the account management system 100 having data customer storage 916 as well as other elements illustrated in FIG. 10. The data storage 916 includes storage for the data 1222, 1224 and 1226 for each of the customers as well as access security 918. Thus, with the proper log-on authorization, a user may access appropriate modules in the same manner as described with respect to the environment 800 of FIGS. 9-11.

The environment 1200 may also include the capability for customer-specific web pages through web hosting software 1212, thus allowing each customer more friendly use of the account management system 100.

The environment 1200 may further include the capability 1230 for automatic e-mail notifications to be sent to users (managers, administrators, sales personnel, technical/field personnel, customers) containing information specifically targeted to the user and tailored to the user's job responsibilities. Such e-mail may entail, for example but without limitation, a notice announcing the award of a new job contract as part of an existing project. The notice may be sent to an account manager, the sales staff which solicited the contract, and the field staff who will have to schedule the necessary equipment.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and CD-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art without departing from the essential function of the invention. The embodiment was chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a computer program product containing instructions for managing customer accounts, projects and jobs in a multi-node, computing environment.

1. An account management system, comprising:
a server interconnected with a network to which client devices operated by users in one or more offices of an organization are interconnected, comprising:
a memory;
a storage device; and
a processor programmed to execute database application instructions whereby database information is accessible to the users, the database application comprising:
an accounts module, comprising:
a general information element for providing general information pertaining to accounts of the organization;
a sales call element for providing information pertaining to prospective accounts; and
a project sites element for providing information pertaining to jobs associated with project sites; and
a document management module for providing access to stored documents searchable by at least one of an associated account, associated project, associated job, an associated office and an associated category.

2. The account management system of claim 1, the database application further comprising an equipment management module, comprising:
an equipment inventory element;
an equipment scheduling element; and
an equipment maintenance scheduling element.

3. The account management system of claim 1, the database application further comprising a financial management module for providing financial information at an account level, a project level and a job level.

4. The account management system of claim 1, the database application operable to generate automatic e-mail notifications to be sent to a user tailored to the job duties of the user.

5. The account management system of claim 1, the database application further comprising an element to automatically generate a customer-specific web site whereby the specific customer is provided with information about the customer's account and associated projects and jobs.

6. The account management system of claim 1, the database application further comprising a financing quote module for providing financing quotes in response to inputs specifying a project type, a project location and desired payment terms.

7. The account management system of claim 6, further comprising an internet connection associated with the financing quotes module whereby access to the financing quotes module is permitted without access to other modules.
